(19) United States
(12) Patent Application Publication
(10) Pub. No.: US 2006/0117369 A1
(43) Pub. Date: Jun. 1, 2006

(54) Network system to manage network printers and local printers and method thereof

(76) Inventor: Ki-moon Lee, Seongnam-si (KR)

Correspondence Address: STANZIONE & KIM, LLP, 919 18TH STREET, N.W., SUITE 440, WASHINGTON, DC, 20006, US

(21) Appl. No.: 11/283,815

(22) Filed: Nov. 22, 2005

(30) Foreign Application Priority Data
Nov. 26, 2004 (KR) 2004-98048

(51) Int. Cl. H04N 7/173; H04N 7/16

(52) U.S. Cl. 725/114; 725/117; 725/144

(57) ABSTRACT

A network system to manage network printers and local printers and a method thereof. The network system includes a first terminal to broadcast an information request packet to request information of image forming apparatuses connected to a predetermined network, and a second terminal connected to a local image forming apparatus to receive the information request packet broadcasted from the first terminal and to transmit information of the local image forming apparatus in response to the information request packet. Accordingly, image forming apparatuses directly and indirectly connected to a network are effectively managed.

### CROSS-REFERENCE TO RELATED APPLICATIONS

This application claims the benefit under 35 U.S.C. § 119 from Korean Patent Application No. 2004-98048 filed on Nov. 26, 2004, in the Korean Intellectual Property Office, which is incorporated herein by reference in its entirety.

### BACKGROUND OF THE INVENTION

1. Field of the Invention

The present general inventive concept is related to a network system to display a list of usable image forming apparatuses, and more particularly, to a network system to display a list of information of image forming apparatuses including network connected image-forming apparatuses and local image-forming apparatuses individually installed at terminals connected through a network.

2. Description of the Related Art

Various computing equipments in a modern office are generally connected through a network. The computing equipments include not only personal computers (PC), but also peripheral devices such as a printer, a scanner, a copier, and a facsimile. The computing equipments are often used by accessing a local area network (LAN) in an office nearby. By connecting the PCs and the peripheral devices through the network and using them through the LAN, expensive peripheral devices can be shared by a plurality of users. Therefore, usage of peripheral devices increases and a maintenance cost of the peripheral device is reduced.

Printers can be connected to a plurality of terminals through an Internet protocol (IP) if a network interface card (NIC) is installed in the printers. Accordingly, the printers can be shared through the network and a plurality of users can use the printers.

A network printer management program is generally installed in a terminal to effectively manage a plurality of network printers connected to the terminal through the network. That is, a user uses the network printer management program to search a current state of the network printers or information of the network printers connected through the network, and to manage the network printers. Web jet-Admin program from HP (Hewlett-Packard) is a representative example of network printer management program.

However, a conventional network printer management program manages only the network printers. A network printer is a printer with a network card installed. However, a local printer cannot be remotely managed by the conventional network printer management program from an external remote location. The local printer is a printer without a network card installed therein or a printer having no networking function. Since the network function is generally not included in conventional printers, there are not many network printers to be managed by a conventional network printer management program. Therefore, the printers are not effectively managed through the network.

### SUMMARY OF THE INVENTION

Accordingly, the present general inventive concept provides a network system and a method of effectively managing a network by exchanging information of a local image forming apparatus installed in a terminal through the terminal.

Additional aspects and advantages of the present general inventive concept will be set forth in part in the description which follows and, in part, will be obvious from the description, or may be learned by practice of the general inventive concept.

The foregoing and/or other aspects of the present general inventive concept are achieved by providing a network system including a first terminal to broadcast an information request packet to request information of image forming apparatuses connected to a predetermined network, and a second terminal connected to a local image forming apparatus to receive the information request packet broadcasted from the first terminal and to transmit information of the local image forming apparatus in response to the information request packet.

The first terminal may include a predetermined network management program to manage network image forming apparatuses connected to the predetermined network, and may create and broadcast the information request packet using the predetermined network management program when a list display command to display a list of image forming apparatuses connected to the network is input after executing the network management program.

The second terminal may include an agent program for analyzing commands created with a predetermined protocol by the predetermined network management program and performing predetermined operations according to the analyzed commands to substitute for the local image forming apparatus.

The first terminal may use one of a SNMP (simple network management protocol) and a CMIP (common management information protocol) to communicate with the second terminal.

The second terminal may receive a printing command from the first terminal and may control the local image forming apparatus to perform a printing operation in response to the printing command.

The first terminal may receive the information of the local image forming apparatus from the second terminal, create the list of image forming apparatuses connected to the network including the local image forming apparatus and display the created list.

The foregoing and/or other aspects of the present general inventive concept may also be achieved by providing a terminal connected to a predetermined local image forming apparatus, including a network interface connected to a predetermined network to receive a packet transmitted through the predetermined network, and an agent unit to receive an information request packet to request information of the predetermined local image forming apparatus through the network interface, and to transmit a predetermined response packet including the information of the predetermined local image forming apparatus in response to the information request packet through the network interface.

The terminal may further include a printer driver unit to control operations of the predetermined local image forming apparatus.

The agent unit may receive a command packet created using a predetermined protocol by a predetermined network management program through the network interface, and analyze the command packet to control the printer driver unit to perform corresponding operations in response to the command packet.

The foregoing and/or other aspects of the present general inventive concept may also be achieved by providing a method of managing a network in a network system having a second terminal connected to a local image forming apparatus and a first terminal connected to the second terminal through a network, the method including broadcasting an information request packet to request information of image forming apparatuses connected to the networkby the first terminal, receiving the information request packet by the second terminal, transmitting information of the local image forming apparatus to the first terminal from the second terminal, and creating a list of image forming apparatuses including the information of the local image forming apparatus and displaying the created list by the first terminal.

The first terminal may include a predetermined network management program and the predetermined network management program manages network image forming apparatuses connected to the network.

The second terminal may include an agent program and the agent program analyzes a command created using a predetermined protocol by the predetermined network management program and performs corresponding operations according to the command to substitute for the local image forming apparatus.

The first terminal and the second terminal may communicate with each other using one of a SNMP (simple network management protocol) and a CMIP (common management information protocol).

The method may further include transmitting a printing command to print predetermined printing data to the second terminal by the first terminal, and controlling the local image forming apparatus to print the predetermined printing data by the second terminal.

The foregoing and/or other aspects of the present general inventive concept may also be achieved by providing a network system including a first terminal to transmit information request packets through a network requesting transmission of predetermined information of network image forming apparatuses, and a second terminal including a predetermined agent program to create information related to non-network image forming apparatuses and to transmit the created information to the first terminal in response to the transmitted information request packets.

The foregoing and/or other aspects of the present general inventive concept may also be achieved by providing a method of managing a non-network printer through a network system, the method including creating and sending information related to the non-network printer through a network in response to a printer information request from a network manager, and transmitting commands and data received from the network to the non-network printer.

The foregoing and/or other aspects of the present general inventive concept may also be achieved by providing a printing system including a network printing manager to transmit information request packets through a network requesting information on printers, to transmit print commands and data to print according to information received through the network in response to the information request packages, and at least one agent unit to create information related to a respective non-network printer and to transmit the created information to the network printing manager in response to the transmitted information request packets, and to receive the print commands and data to print from the network printing manager and forward the received print commands and data to the respective non-network printer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram illustrating a network system according an embodiment of the present general inventive concept;

FIG. 2 is a block diagram illustrating a first terminal of the network system of FIG. 1;

FIG. 3 is a block diagram illustrating a second terminal of the network system of FIG. 1;

FIG. 4 is a block diagram illustrating a local image forming apparatus of the network system of FIG. 1; and

FIGS. 5 and 6 are flowcharts illustrating a method of managing a network according an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

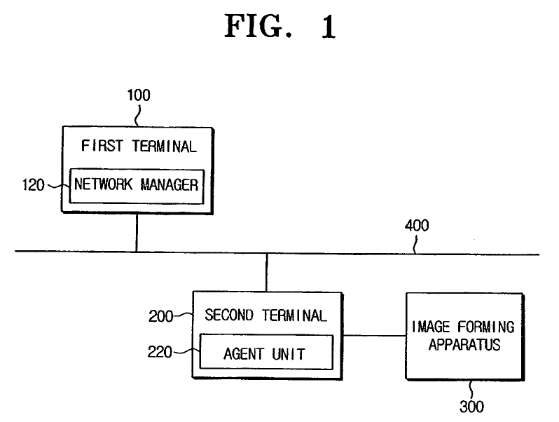

FIG. 1 is a block diagram illustrating a network system according an embodiment of the present general inventive concept.

Referring to FIG. 1, the network system includes a first terminal 100, a second terminal 200, and a local image forming apparatus 300 directly connected to the second terminal 200. The first terminal 100 and the second terminal 200 are connected through a network 400, such as, for example, an Ethernet network. The network system of FIG. 1 illustrates use of the first terminal 100 and the second terminal 200 only, but the network system according to the present general inventive concept may include additional terminals and network printers connected through the network 400.

The first terminal 100 includes a network manager 120. The network manager 120 manages network image forming apparatuses connected to the network 400 using a predetermined network management program. The predetermined network management program is software developed by a printer manufacturer for effectively managing network printers. Web jet admin of HP is a representative one of the network management programs.

A user of the first terminal 100 can request a list of usable image forming apparatuses connected to the network 400 by executing the predetermined network management program. The network manager 120 of the first terminal 100 broadcasts an information request packet through the network 400 to request information of the image forming apparatuses connected to the network 400. The network image forming apparatuses connected to the network 400 transmit information of the network image forming apparatuses, including a MAC (Media Access Control) address, a model name, a manufacturer, etc., in response to the information request packet. The terminal 100 receives the information of the network image forming apparatuses, creates a list of the network image forming apparatuses with the received information, and displays the created list.

The second terminal 200 includes an agent unit 220. The agent unit 220 performs predetermined operations that substitute the local image forming apparatus 300 connected to the second terminal 200. That is, if the second terminal 200 receives the information request packet broadcasted from the first terminal 100, the agent unit 200 responds to the information request packet in a same manner as any network image forming apparatus would respond. Accordingly, the predetermined network management program of the first terminal 100 recognizes the local image forming apparatus 300 of the second terminal 200 as the network image forming apparatus.

In order to respond to the information request packet, a predetermined agent program is installed in the second terminal 200. The predetermined agent program is software analyzing commands created using a predetermined type of protocol by the predetermined network management program. The predetermined type of protocol used by the predetermined network management program and the predetermined agent program may be a simple network management protocol (SNMP), or a common management information protocol (CMIP).

As described above, the second terminal 200 analyzes packets broadcasted from the first terminal 100 and performs corresponding operations. For example, if the first terminal 100 broadcasts the information request packet to request information of the local image forming apparatus 300, the second terminal 200 creates the information of the local image forming apparatus 300 using one of the SNMP and the CMIP and transmits the created information to the first terminal 100.

After the first terminal 100 receives the information of the local image forming apparatus, the first terminal 100 creates and displays the list of the information of usable image forming apparatuses including the list of the network image forming apparatuses and the information of the local image forming apparatus. A user of the first terminal 100 may then select the local image forming apparatus 300 in the displayed list of usable image forming apparatuses and send a printing command to the selected local image forming apparatus 300. When the user inputs the printing command, the first terminal 100 uses the predetermined network management program to transmit the printing command to the second terminal 200. Then, the second terminal 200 recognizes the printing command transmitted from the first terminal 100 by using the predetermined agent program. Finally, the local image forming apparatus 300 performs a printing operation according to the printing command transmitted from the first terminal 100.

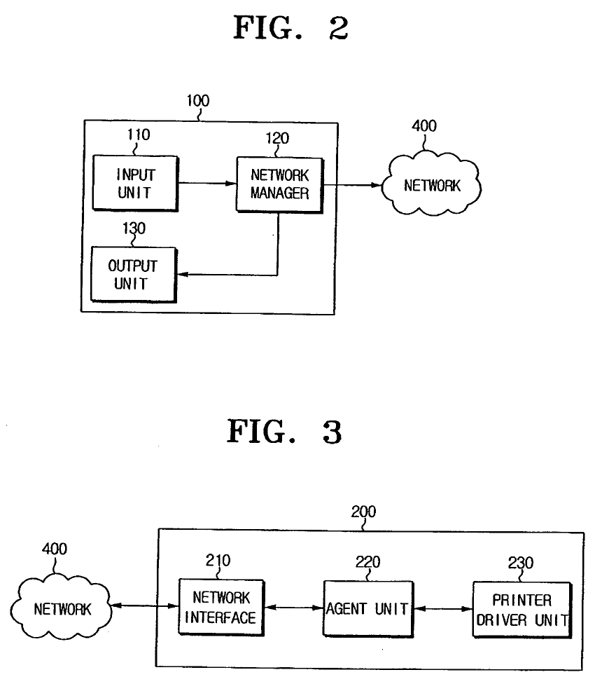

FIG. 2 is a block diagram illustrating the first terminal of the network system of FIG. 1.

Referring to FIG. 2, the first terminal 100 includes an input unit 110, a network manager 120, and an output unit 130. The input unit 110 may receive various commands, such as a list display command to display the list of usable image forming apparatuses or a print command to print a predetermined printing data. If the list display command is received through the input unit 110, the network manager 120 transmits the information request packet not only to the network image forming apparatuses, but also to the terminals connected with local image forming apparatuses and having the predetermined agent program through the network 400. When the terminals connected to respective local image forming apparatuses transmit the information of the local image forming apparatuses to the first terminal 100, the output unit 130 displays the list of usable image forming apparatuses that is formed with both the information of the network image-forming apparatuses and the information of the local image forming apparatuses.

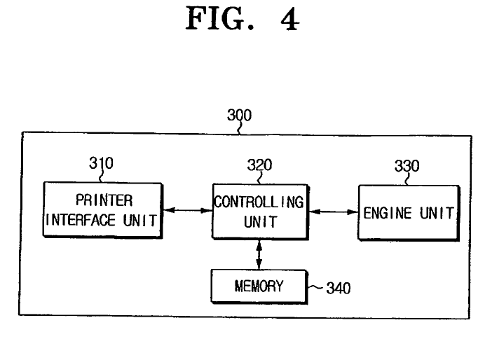

FIG. 3 is a block diagram illustrating the second terminal of the network system of FIG. 1.

Referring to FIG. 3, the second terminal 200 may include a network interface 210, an agent unit 220 and a printer driver unit 230.

The network interface 210 is connected to the network 400 to relay communication data between the second terminal 200 and the network 400. When the information request packet is received through the network interface 210, the agent unit 220 analyzes the received information request packet. The agent unit 220 receives information from the local image forming apparatus 300 and transmits the received information to the first terminal 100.

The printer driver unit 230 enables the second terminal 200 to recognize the local image forming apparatus 300 connected thereto and to communicate with the local image forming apparatus 300. The printer driver unit 230 converts commands of a general operating system to commands to be recognized by the local image forming apparatus 300.

The agent unit 220 enables the second terminal 200 to obtain the information of the location image forming apparatus 300 by communicating with the local image forming apparatus 300. The obtained information is transmitted to the first terminal 100 through the network interface 210.

When the second terminal 200 receives a packet to control a predetermined operation of the local image forming apparatus 300, the agent unit 200 analyzes the received packet and controls the local image forming apparatus 300 according to the received packet. That is, when the second terminal 200 receives a packet to print a predetermined data using the local image forming apparatus 300 or a packet to request a current state of the local image forming apparatus 300 from the first terminal 100, the agent unit 200 controls the printer driver unit 230 to perform corresponding operations according to the received request. Occasionally, the agent unit 220 may execute a predetermined application program.

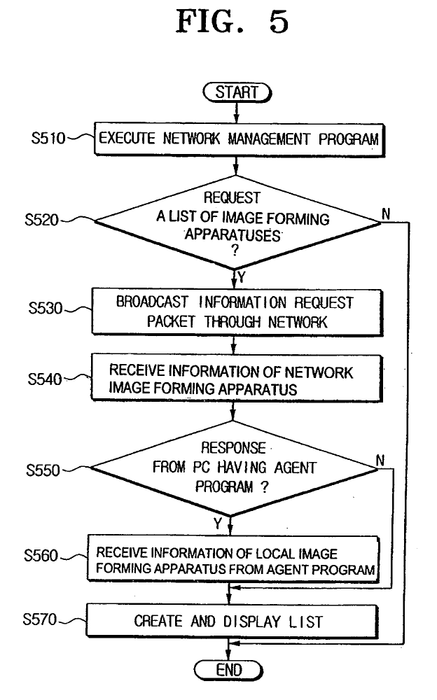

FIG. 4 is a block diagram illustrating a local image forming apparatus used with the network system of FIG. 1.

Referring to FIG. 4, the local image forming apparatus 300 may include a printer interface unit 310, a controlling unit 320, an engine unit 330, and a memory 340. The printer interface unit 310 can be connected to the second terminal 200 to relay data between the controlling unit 320 and the agent unit 220. The printer interface unit 310 may be an USB (Universal Serial Bus) port or a general parallel port.

The controlling unit 320 receives various data from a host which may be the terminal 200, analyzes a text code of the received data or a control command, and generally controls the local image forming apparatus 300.

The memory 340 stores information of the local image forming apparatus. The information may be an identification of the local image forming apparatus 300, a model name, a manufacturing number, a manufacturer and a date of manufacturing. The controlling unit 320 may transmit the information stored in the memory 340 to the agent unit 220 when the agent unit 220 of the second terminal 200 requests the information of the local image forming apparatus.

The controlling unit 320 controls the engine unit 330 to perform a printing operation when a printing command with printing data is transmitted through the second terminal 200. The engine unit 330 actually performs the printing operation. In a case of a laser printer, the engine unit 330 includes a paper supply unit, a discharging lamp, a laser scanning unit, a photoreceptor drum, and a developer roller.

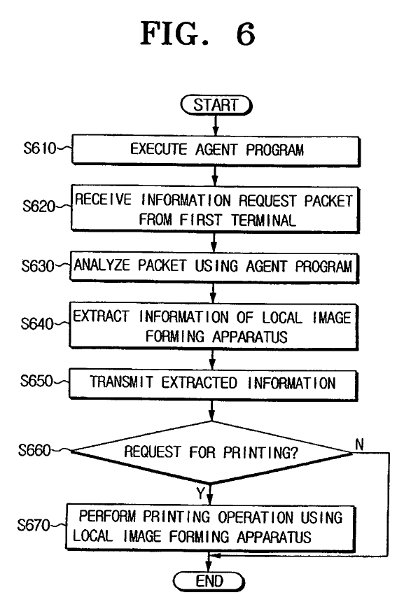

FIGS. 5 and 6 are flowcharts illustrating a method of managing a network according an embodiment of the present general inventive concept.

Operations of the first terminal 100 illustrated in FIG. 2 will be described with reference to FIG. 5. Referring to FIG. 5, a user executes the predetermined network management program in operation S510, and the list of usable image forming apparatuses connected to the network 400 is requested in operation S520. Then, the first terminal 100 broadcasts the information request packet to the network in operation S530.

Accordingly, the first terminal 100 receives the information of network image forming apparatuses connected to the network 400 in operation S540.

When the first terminal 100 receives a response from the second terminal 200 having the predetermined agent program in operation S550, the first terminal 100 receives the information of the local image forming apparatus 300 managed by the predetermined agent program by communicating with the second terminal 200 in operation S560.

The first terminal 100 creates the list of image forming apparatuses including network image forming apparatuses and usable local image forming apparatuses 300 and displays the list, in operation S570.

Hereinafter, operations of the second terminal 200 illustrated in FIG. 3 will be described with reference to FIG. 6.

Referring to FIG. 6, the predetermined agent program is executed in operation S610. When the second terminal 200 receives the information request packet to request information of the local image forming apparatus from the first terminal 100 having the predetermined network management program in operation S620, the second terminal 200 analyzes the information request packet using the predetermined agent program in operation S630.

The agent unit 220 extracts the information of the local image forming apparatus 300 in operation S640 and transmits the extracted information to the first terminal 100 in operation S650. In order to transmit the extracted information, the predetermined agent program creates an information packet using a predetermined protocol assigned for a communication between the predetermined agent program and the predetermined network management program. As described above, the protocol may be the CMIP (common management information protocol) or the SNMP (simple network management protocol).

When the second terminal 200 receives the printing command and the printing data in operation S660, the second terminal 200 controls the local image forming apparatus 300 to perform the printing operation in operation S670. In order to control the local image forming apparatus, the second terminal 200 converts the printing data to a predetermined format of data to be recognized by the controlling unit 320 of the local image forming apparatus 300 by executing the printer driver program related to the local image forming apparatus 300. Accordingly, the controlling unit 320 performs the printing operation by controlling the engine unit 330.

As described above, the network image forming apparatuses and the local image forming apparatuses connected directly and indirectly to the network are effectively managed and used according to the present general inventive concept. That is, the network system according to the present general inventive concept effectively manages the local image forming apparatus, which is an image forming apparatus with no network card installed or an image forming apparatus having no networking function, through a host device directly connected to the local image forming apparatus and connected to the network. Accordingly, a user conveniently checks a state of the entire network by using the network system according to the present general inventive concept.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A network system comprising:
a first terminal to broadcast an information request packet to request information of image forming apparatuses connected to a predetermined network; and
a second terminal connected to a local image forming apparatus to receive the information request packet broadcasted from the first terminal and to transmit information of the local image forming apparatus in response to the information request packet.

2. The network system of claim 1, wherein the first terminal comprises a predetermined network management program to manage network image forming apparatuses connected to the predetermined network, and creates the information request packet using the predetermined network management program when a list display command to display a list of image forming apparatuses connected to the network is input after executing the network management program.

3. The network system of claim 2, wherein the second terminal includes an agent program and the agent program analyzes commands created with a predetermined protocol by the predetermined network management program and performs predetermined operations according to the analyzed commands to substitute for the local image forming apparatus.

4. The network system of claim 3, wherein the first terminal communicates to the second terminal using one of a SNMP (simple network management protocol) and a CMIP (common management information protocol).

5. The network system of claim 3, wherein the second terminal receives a printing command from the first terminal and controls the local image forming apparatus to perform a printing operation in response to the printing command.

6. The network system of claim 3, wherein the first terminal receives the information of the local image forming apparatus from the second terminal, creates the list of image forming apparatuses connected to the network including the local image forming apparatus and displays the created list.

7. A terminal connected to a predetermined local image forming apparatus, comprising:
a network interface connected to a predetermined network to receive a packet transmitted through the predetermined network; and
an agent unit to receive an information request packet to request information of the predetermined local image forming apparatus through the network interface, and to transmit a predetermined response packet including the information of the predetermined local image forming apparatus in response to the information request packet through the network interface.

8. The terminal of claim 7, further comprising a printer driver unit to control operations of the predetermined local image forming apparatus.

9. The terminal of claim 7, wherein the agent unit receives a command packet created using a predetermined protocol by a predetermined network management program through the network interface, and analyzes the command packet to control the printer driver unit to perform corresponding operations in response to the command packet.

10. A method of managing a network in a network system having a second terminal connected to a local image forming apparatus and a first terminal connected to the second terminal through a network, the method comprising:
broadcasting an information request packet to request information of image forming apparatuses connected to the network by the first terminal;
receiving the information request packet by the second terminal;
transmitting information of the local image forming apparatus to the first terminal from the second terminal; and
creating a list of image forming apparatuses including the information of the local image forming apparatus and displaying the created list by the first terminal.

11. The method of claim 10, wherein the first terminal includes a predetermined network management program and the predetermined network management program manages network image forming apparatuses connected to the network.

12. The method of claim 11, wherein the second terminal includes an agent program and the agent program analyzes a command created using a predetermined protocol by the predetermined network management program and performs corresponding operations according to the command to substitute for the local image forming apparatus.

13. The method of claim 12, wherein the first terminal and the second terminal communicate with each other using one of a SNMP (simple network management protocol) and a CMIP (common management information protocol).

14. The method of claim 12, further comprising:
transmitting a printing command to print predetermined printing data to the second terminal by the first terminal; and
controlling the local image forming apparatus to print the predetermined printing data by the second terminal.

15. A method of managing a non-network printer through a network system, the method comprising:
creating and sending information related to the non-network printer through a network in response to a printer information request from a network manager; and
transmitting commands and data received from the network to the non-network printer.

16. A printing system comprising:
a network printing manager to transmit information request packets through a network requesting information on printers, to transmit print commands and data to print according to information received through the network in response to the information request packages; and
at least one agent unit to create information related to a respective non-network printer and to transmit the created information to the network printing manager in response to the transmitted information request packets, and to receive the print commands and data to print from the network printing manager and forward the received print commands and data to the respective non-network printer.

17. The printing system of claim 16, wherein the network printing manager generates a list of network and non-network printers associated therewith using the received information in response to the transmitted information request packets, and broadcasts the list to a plurality of terminals connected to the network.

18. The printing system of claim 16, wherein the at least one agent unit comprises:
a printer driver unit to transmit the print commands and the data to print to the respective non-network printer through one of an USB port and a general parallel port.
